(19) United States
(12) Patent Application Publication
(10) Pub. No.: US 2015/0197432 A1
(43) Pub. Date: Jul. 16, 2015

(54) WATER OUTFLOW FITTING AND METHOD FOR OPERATING SUCH A WATER OUTFLOW FITTING

(71) Applicant: GEBERIT INTERNATIONAL AG, Jona (CH)

(72) Inventors: Roland WIDLER, Hittnau (CH); Joachim KECK, Nendeln (DE)

(73) Assignee: GEBERIT INTERNATIONAL AG, Jona (CH)

(21) Appl. No.: 14/613,456

(22) Filed: Feb. 4, 2015

Related U.S. Application Data
(63) Continuation of application No. 12/898,304, filed on Oct. 5, 2010, now abandoned.

(30) Foreign Application Priority Data
Oct. 6, 2009 (EP) 09 405 176.0

(51) Int. Cl. C02F 1/467

(52) U.S. Cl. CPC C02F 1/4672; C02F 2201/4612

(57) ABSTRACT

The water outflow fitting has a fitting body (2) which possesses a water duct (4) with an inlet and an outlet (3). A water valve (7) and means (14) for disinfecting the water are arranged in the water duct (4). The means (14) for disinfecting the water is an electrochemical cell (14) arranged in the water duct (4). Preferably, the electrochemical cell (14) is arranged in the water duct (4) in a region in which standing water is located when the water valve (7) is closed and flowing water is located when the water valve is open, the electro-chemical cell (14) being located in standing water in the first case and being washed around or washed through by water in the second case. Preferably, in the event of the fitting being used, the electrochemical cell (14) is activated by means of a proximity sensor (12).

This is a Continuation of application Ser. No. 12/898,304 filed Oct. 5, 2010, claiming priority based on European Patent Application No. 09 405 176.0 filed Oct. 6, 2009, the contents of all of which are incorporated herein by reference in their entirety.

### FIELD OF THE INVENTION

The invention relates to a water outflow fitting with a fitting body which has a water duct with an inlet and an outlet, having a water valve and having means for disinfecting the water.

### BACKGROUND OF THE INVENTION

A water outflow fitting of this type became known in the prior art from U.S. Pat. No. 7,488,419. This possesses an ozonizer which is connected via an air line to an insert in the outlet. Ozone can be supplied to the water directly at the outlet via the line, and consequently impurities and, in particular, bacteria can be destroyed. By means of the ozone, organic pollution caused by oxidation can be mineralized. As compared with disinfection, likewise known, by means of UV lamps, disinfection by oxidation by means of ozone is substantially more efficient. However, the generation of ozone from air is comparatively complicated, and this applies likewise to the supply of the ozone to the outlet by means of an air line.

The object on which the invention is based is to provide a water outflow fitting of the type mentioned which ensures even higher reliability.

In a generic water outflow fitting, the object is achieved in that the means for disinfecting the water is an electrochemical cell arranged in the water duct. It is essential and advantageous for the invention that the ozone is generated directly where the water is used. The electrochemical cell therefore does not disinfect the water at a point on a supply line which is far away from the outlet, but, instead, in the immediate vicinity of the outlet. Bacterial recontamination can thereby be avoided. An appliance for the generation of ozone outside the fitting and a corresponding air line are unnecessary.

Electrochemical cells for the disinfection of water are known per se, for example, from WO 2006/092125. Hitherto, however, such cells have been arranged in the supply line. In a hot-water fitting having a mixing valve, therefore, two such electrochemical cells would have been necessary, one in the hot-water line and the other in the cold-water line. The water outflow fitting according to the invention ensures high reliability and water quality.

### SUMMARY OF THE INVENTION

According to a development of the invention, there is provision for the electrochemical cell to be arranged in the water duct in a region in which standing water is located when the water valve is closed and flowing water is located when the water valve is open, and for the electrochemical cell to be located in standing water in the first case and to be washed around or washed through by water in the second case. This ensures that the electrodes of the electrochemical cell are always located in water and therefore cannot dry out. This is ensured especially reliably when the electrochemical cell is located in an ascending region of the water duct. The electrochemical cell may be located downstream or upstream of the water valve, as seen in the direction of flow. Preferably, however, the electrochemical cell is arranged downstream of the water valve in an ascending region of the water duct.

Especially reliable and complete disinfection is ensured when, according to a development of the invention, a mixing unit is arranged downstream of the electrochemical cell, as seen in the direction of flow, in which mixing unit oxidizing agent dispensed by the electrochemical cell is intermixed with water. This mixing unit is likewise preferably arranged in an ascending region of the water duct. Intermixing preferably takes place directly below the water level of the ascending region.

Due to the arrangement of the electrochemical cell within the duct the ozone is generated directly from the water that flows in said duct. Therefore an effective ozone generation is possible at the spot where ozone is needed.

According to a development of the invention, there is provision for the water outflow fitting to have at least one sensor connected to a control unit, for the control unit to be connected to the electrochemical cell, and for the electrochemical cell to be activatable via the sensor. It is thereby possible to activate the electrochemical cell exactly when water is to be extracted from the water outflow fitting. The sensor is, for example, a proximity sensor which responds, for example, to the movement of a hand. At the same time, via such a proximity sensor, the water valve can be opened and closed. If, for example, a hand comes into the vicinity of such a proximity sensor, the electrochemical cell is activated and therefore starts to dispense an oxidizing agent into the water. The water valve is opened essentially simultaneously. When the hand is no longer located in the range of coverage of the sensor, the water valve is correspondingly closed and the electrochemical cell is deactivated.

According to a development of the invention, there is provision for measurement means for determining the ozone concentration in the water to be arranged in the water duct downstream of the electrochemical cell, as seen in the direction of flow. Such means make it possible to control the electrochemical cell particularly with regard to the quality of the water. Moreover, it is possible to monitor the electrochemical cell. For this purpose, according to a development of the invention, there is provision for the water outflow fitting to have indicator means for the measured ozone concentration. If the ozone concentration falls below a predetermined value, this is indicated correspondingly. The indicator means possesses, for example, a green and a red diode. If the green diode lights up, the measured ozone concentration is in the intended range. If the red diode lights up, the ozone concentration is insufficient. The water valve can correspondingly be controlled such that the valve does not open or close in the event of insufficient ozone concentration.

According to a development of the invention, there is provision for the water outflow fitting to have means for measuring the water quality. These measurement means measure, for example, the organic load of the disinfected water. Measurement takes place, for example, via the redox potential of the water. During such measurement, possible bacterial contamination is also measured. Preferably, there is provision for the electrochemical cell to be controlled on the basis of the measurement of the water quality. The higher the pollution of the water, the correspondingly higher is the production of the oxidizing agent. The said measurement means are preferably arranged directly at the exit of the water duct or at the exit of a mixing chamber.

According to a development of the invention, alarm means are provided which respond as soon as a predetermined value relating to the water quality is overshot. The alarm means may have an optical indicator and may be designed in such a way that, at the same time, the water valve is closed and/or can no longer be opened.

The invention relates, moreover, to a method for operating a water outflow fitting. In this method, the electrochemical cell is regulated according to at least one criterion by a measurement means arranged in the water duct.

### BRIEF DESCRIPTION OF THE DRAWINGS

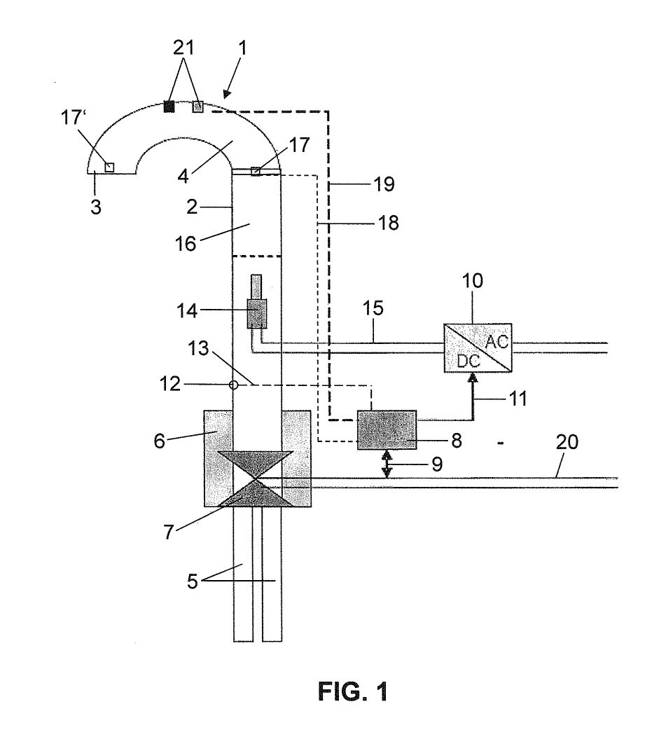

An exemplary embodiment of the water outflow fitting according to the invention is explained below by means of FIG. 1. The figure shows diagrammatically a water outflow fitting according to the invention.

### DESCRIPTION OF THE EMBODIMENT

The water outflow fitting 1 possesses an essentially tubularly designed housing 2 which can be mounted by means of a base 6, for example, on a wash-stand, not shown here. A water duct 4, in which a water valve, for example a solenoid valve, is arranged, runs in the housing 2. The water valve 7 is, for example, a mixing valve and is connected to two water lines 5. One of these water lines 5 is intended for hot water and the other for cold water. The valve 7 is controlled via an electrical line 20. Via a control unit 8, the water valve 7 can be opened and closed by means of a sensor 12. For this purpose, the sensor 12 is connected via a signal line 13 to the control unit 8 and the latter is connected by means of a signal line 9 to the water valve 7. The sensor 12 is, in particular, a proximity sensor. Sensors of this type are known per se and therefore need not be explained in more detail here. If the water valve 7 is open, water flows out of the water lines 5 through the water duct 4 to an outlet 3. The opening of the water valve 7 may take place, for example, contactlessly by means of a hand movement.

Arranged in the water duct 4 is an electrochemical cell 14. As can be seen, this cell is located in the rising region of the water duct 4 and is therefore surrounded by water even when the water valve 7 is closed. The electrical supply of the electrochemical cell 14 takes place via a transformer 10 and an electrical line 15. The electrochemical cell 14 is designed as a module and possesses, in a way known per se, an anode and a cathode which are not shown here. If a direct voltage is applied to the electrodes, oxidizing substances are generated at the electrodes on account of chemical reactions known per se and have a disinfecting action upon organic substances in the water. The electrodes are, for example, of a type provided with a boron-doped diamond coating.

A mixing unit 16 is arranged downstream of the electro-chemical cell, as seen in the direction of flow. In this mixing unit, the substances dispensed at the electrochemical cell 14 and, in particular, oxidative substances, for example ozone, are mixed with the water. The oxidative substances are thus distributed uniformly in the water. These substances destroy or mineralize the organic substances present and therefore, for example, harmful bacteria very quickly. The water emerging from the outlet 3 thus essentially no longer contains any organic substances and is therefore disinfected.

At the exit of the mixing unit 16, a sensor 17 is arranged, which is connected via a signal line 18 to the control unit 8. This sensor 17 serves for determining the ozone concentration in the water which emerges from the mixing unit 16. The ozone concentration at the exit of the mixing unit 16 is calibrated to a specific water quality. If the water quality changes, for example in that the organic fraction in the water increases, the output of the electrochemical cell 14 correspondingly tracks this or is increased. Regulation takes place on the basis of the measurement of the sensor 17. If the fraction of organic substances falls, less ozone is correspondingly required for their mineralization. The ozone concentration rises correspondingly. In this case, regulation leads to a reduction in the output of the electrochemical cell 14. What is achieved by virtue of this regulation is that in each case the optimal quantity of oxidizing substances is generated in the water.

Instead of ozone concentration measurement, another parameter of the water may also be measured. For example, the redox potential may be measured. The electrochemical cell 14 is then regulated on the basis of this measurement. The output of the electrochemical cell 14 then tracks the corresponding water quality. Other parameters or criteria, which are related to the water quality or bacterial contamination and can be used for regulation, may also be envisaged.

The sensor 17 may alternatively also be arranged as a sensor 17′ directly in the region of the outlet 3. An arrangement of two sensors 17 and 17′ would also be possible. Influence upon the water in the region of the outlet 3 could thereby be taken into account.

The electrochemical cell 14 is controlled such that it is activated essentially upon the opening of the water valve 7. The disinfection of the water consequently takes place only as required. After the closing of the water valve 7, the electrochemical cell 14 is correspondingly deactivated.

Pilot lights 21 are arranged in a visually perceptible manner on the housing 2 and are connected to the control unit 8 via a signal line 19. The pilot lights 21 indicate the water state on the basis of the measurement of the sensor 17. Thus, in the case of a sensor 17′, the water state at the outlet 3 is indicated. A green light indicates, for example, that the water quality is adequate, whereas a red light indicates an unsatisfactory water quality. In the case of unsatisfactory water quality, the water valve 7 is preferably closed automatically and temporarily cannot be opened.

The ozone concentration measured by means of the sensor is, of course, higher than the ozone concentration measured at the outlet 3 by means of the sensor 17′. The maximum ozone concentration in the region of the sensor 17′ amounts, for example, to 0.05 mg per litre. This concentration may be twice as high in the region of the sensor 17. Ozone production is greater, the greater the volume flow is. A higher organic load and higher conductivity reduce the concentration of ozone in the region of the sensors 17 and 17′. By virtue of the abovementioned regulation, then, this ozone concentration can be set or regulated optimally.

### LIST OF REFERENCE SYMBOLS

1 Water outflow fitting
2 Housing
3 Outlet
4 Water duct
5 Water lines
6 Base
7 Water valve
8 Control unit
9 Signal line
10 Transformer
11 Signal line
12 Proximity sensor
13 Signal line
14 Electrochemical cell
15 Electrical line
16 Mixing unit
17 Sensor
18 Signal line
19 Signal line
20 Electrical line
21 Pilot light

1. Water outflow fitting with a fitting body which has a water duct with an inlet and an outlet, having a water valve and having means for disinfecting the water, wherein the means for disinfecting the water is an electrochemical cell arranged in the water duct.

2. Water outflow fitting according to claim 1, wherein the electrochemical cell is arranged in the water duct in a region in which standing water is located when the water valve is closed and flowing water is located when the water valve is open, the electrochemical cell being located in standing water in the first case and being washed around or washed through by water in the second case.

3. Water outflow fitting according to claim 2, wherein the ozone is generated from water flowing through said water duct.

4. Water outflow fitting according to claim 1 or 2, wherein the electrochemical cell is arranged in an ascending region of the water duct.

5. Water outflow fitting according to claim 1 or 2, wherein the electrochemical cell is arranged downstream or upstream of the water valve, as seen in the direction of flow.

6. Water outflow fitting according to claim 1, wherein at least one mixing unit is arranged downstream of the electrochemical cell, as seen in the direction of flow, in which mixing unit oxidizing agent dispensed by the electrochemical cell is intermixed with water.

7. Water outflow fitting according to claim 6, wherein the at least one mixing unit is arranged downstream of the water valve and downstream of the electrochemical cell, as seen in the direction of flow.

8. Water outflow fitting according to claim 7, wherein the at least one mixing unit is arranged in an upper region of a standing water column when the water valve is closed.

9. Water outflow fitting according to claim 1, wherein it has at least one proximity sensor connected to a control unit, wherein the control unit is connected to the electrochemical cell, and wherein the electrochemical cell is activatable via the proximity sensor.

10. Water outflow fitting according to claim 9, wherein the sensor is a proximity sensor.

11. Water outflow fitting according to claim 1, wherein, in the water duct downstream of the electrochemical cell, as seen in the direction of flow, it has measurement means for determining the ozone concentration in the water.

12. Water outflow fitting according to claim 11, wherein the electrochemical cell is regulated by means of the measured ozone concentration.

13. Water outflow fitting according to claim 12, wherein the said means are arranged at the exit of the at least one mixing unit and/or at the outlet of the water duct.

14. Water outflow fitting according to claim 1, wherein it has means for determining a parameter which is relevant to the water quality, and in that the electrochemical cell is regulated on the basis of this measurement.

15. Water outflow fitting according to claim 1, wherein it has indicator means which give an indication of the water state.

16. Method for operating a water outflow fitting according claim 1, wherein the water outflow fitting has a control device and the electrochemical cell is regulated by means of a sensor arranged in the water duct.

17. Method according to claim 16, wherein the sensor responds to ozone in the water and the electrochemical cell is regulated according to the ozone concentration determined.

18. Method according to claim 16, wherein the ozone concentration is measured at the exit of a mixing unit.
